(19) United States
(12) Patent Application Publication
(10) Pub. No.: US 2023/0138994 A1
(43) Pub. Date: May 4, 2023

(54) AN ANIMAL AND LIVESTOCK FEED SUPPLEMENT

(71) Applicant: BASILIANUS BASUKI NUGROHO Edward, Tangerang Selatan (ID)

(72) Inventor: Sucipto KOKADIR, Jarkata Barat (ID)

(21) Appl. No.: 17/771,408

(22) PCT Filed: Jun. 22, 2020
(86) PCT No.: PCT/IB2020/055886

§ 371 Date: Apr. 22, 2022

(30) Foreign Application Priority Data
Aug. 29, 2019 (ID) P00201907575
Sep. 24, 2019 (ID) P00201908429
Feb. 14, 2020 (ID) S00202001315
Mar. 16, 2020 (ID) S00202002076

(51) Int. Cl. A23K 10/16; A23K 50/10; A23K 10/30; A23K 40/10

(52) U.S. Cl. CPC A23K 10/16; A23K 50/10; A23K 10/30; A23K 40/10

(57) ABSTRACT

The production of a powdered nutritional supplement for the addition to an animal feed may herein be described. The production may involve the steps of weighing one or more dry ingredients and wet ingredients, combining the dry ingredients separately, combining the wet ingredients separately, combining the wet ingredients with the dry ingredients, mixing the ingredients to form a fermentation substrate, then fermenting the fermentation substrate to form a fermented slurry, drying the fermented slurry to form a cake; and milling the cake to make the powdered nutritional supplement for the addition to an animal feeds.

### RELATED APPLICATIONS

This application claims the benefit of Indonesian patent number P00201908429, filed Sep. 24, 2019; P00201907575, filed Aug. 29, 2019; S00202001315, filed Feb. 14, 2020; and S00202002076, filed Mar. 16, 2020, the contents of each of which are incorporated by this reference in their entireties for all purposes as if fully set forth herein.

### TECHNICAL FIELD

The disclosure herein relates generally to the production of a feed supplement for livestock. More particularly, the disclosure relates to the use of Black Cumin in combination with a fermentation step principally performed by lactic acid bacteria. Even more particularly, this disclosure herein relates to a biotechnological fermentation of the plant species Nigella sativa by lactic acid bacteria for use in livestock feeds for livestock, including but not limited to bird, fish, cow, rabbit, pig, and buffalo.

### BACKGROUND

Fermentation may be described as a metabolic process that produces chemical changes in organic substrates through the action of enzymes. Additionally, fermentation may be described as the decomposition of organic compounds to produce energy and new products due to the alteration of an organic substrate with the help of various microorganisms, i.e., bacteria.

Black cumin, whose botanical name is Nigella sativa, is a kind of annual flowering plant with myriad benefits. Black cumin, also known as black caraway, nigella, kalo jeera, kalonji, or kalenji, may belong in the family Ranunculaceae, and be native to a large region of the eastern Mediterranean, North Africa, the Indian Sub-continent, and West Asia. Nigella sativa may grow to approximately 20-30 cm (7.9-11.8 in) tall, with finely divided, linear (but not thread-like) leaves. The flowers may be delicate and usually colored pale blue and white, with five to ten petals. The fruit may be a large and inflated capsule composed of three to seven united follicles, each containing numerous seeds which may be used as a spice. In the United States, the Food and Drug Administration classifies Nigella sativa L. (black cumin, black caraway) as Generally Recognized as Safe (GRAS) for use as a spice, natural seasoning, or flavoring. The seeds of N. sativa are used as a spice in Indian and Middle Eastern cuisines, and also in Polish cuisine. The black seeds taste like a combination of onions, black pepper, and oregano. They have a pungent, bitter taste and smell. In Palestine, the seeds are ground to make bitter qizha paste. The dry-roasted seeds flavor curries, vegetables, and pulses. They can be used as a seasoning in recipes with pod fruit, vegetables, salads, and poultry. In some cultures, the black seeds are used to flavor bread products and are used as part of the spice mixture panch phoron (meaning a mixture of five spices) and alone in many recipes in Bengali cuisine and most recognizably in naan. Nigella sativa is also used in Armenian string cheese, a braided string cheese called majdouleh or majdouli in the Middle East.

Oils may comprise 32% to 40% of the total composition of N. sativa seeds. N. sativa oil may contain linoleic acid, oleic acid, palmitic acid, and trans-anethole, and other minor constituents, such as nigellicine, nigellidine, nigellimine, and nigellimine N-oxide. Aromatics may further include thymoquinone, dihydro-thymoquinone, p-cymene, carvacrol, α-thujene, thymol, α-pinene, β-pinene, and trans-anethole. Protein and various alkaloids may also be present in the seeds.

The benefits of black cumin have been studied by researches extensively, and various studies have been performed by researchers on a global basis. Many studies suggest that the addition of black cumin into livestock fooder may have a positive impact on said livestock. However, one meta-analysis of clinical trials found some evidence that N. sativa may have a short-term benefit on lowering systolic and diastolic blood pressure, with limited evidence that various extracts of black seed can reduce triglycerides and LDL and total cholesterol while raising HDL cholesterol. There is considerable use of N. sativa in traditional medicine practices in Africa and Asia, there may be evidence to indicate that consuming the seeds or oil provides some benefit to human health.

For livestock, Nigella sativa may have several benefits as well, for example, it may function as an antibacterial, an anti-inflammatory may possess anti-tumor properties, and may increase pathogenic resistance. These benefits may have been the driver of the plant being used as a traditional medicinal herb for humans throughout history and may have also been the cause for its identification in various historic and modern apothecary journals. Accordingly, black cumin may turn out to apply to both humans and also for livestock. The substances contained within the black cumin may even be used to replace other antibiotics and may result in an increased immune response for livestock.

Accordingly, what is needed may be a supplement derived from a base ingredient of Nigella sativa flour for the growth of livestock such as fish, bird, chicken, cow, pig, and other cattle.

### SUMMARY

Certain deficiencies of the prior art are overcome by the provision of embodiments of an apparatus, kit, method, and system per the present disclosure. Accordingly, the novel method disclosed herein may involve the following steps including but not limited to weighing one or more dry ingredients and wet ingredients, combining the dry ingredients separately, combining the wet ingredients separately, combining the wet ingredients with the dry ingredients, mixing the ingredients to form a fermentation substrate, then fermenting the fermentation substrate to form a fermented slurry, drying the fermented slurry to form a cake; and milling the cake to make a powdered nutritional supplement for the addition to an animal feeds.

The ingredients may include wheat flour, Nigella sativa flour, lactic acid bacteria, and purified water. The lactic acid bacteria may be selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella. Fermentation may be allowed to proceed until all the usable biologic elements are consumed by the lactic acid bacteria.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are not to be considered limiting of its scope, the disclosure will be described with additional specificity and detail through the use of accompanying drawings. Accordingly, further advantages of the present disclosure may become apparent to those skilled in the art with the benefit of the following detailed description of the preferred embodiments and upon reference to the accompanying drawings in which:

FIG. 1 is a simplified flow diagram illustrating a method for producing a powdered nutritional supplement for the addition to an animal feed according to one non-limiting embodiment; and,

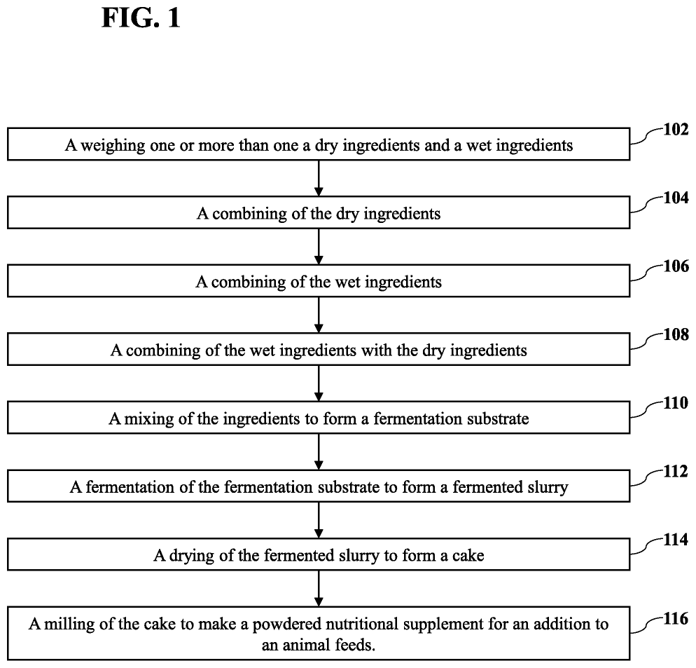

FIG. 2 is a simplified flow diagram illustrating a method for producing a powdered nutritional supplement for the addition to an animal feed according to one non-limiting embodiment.

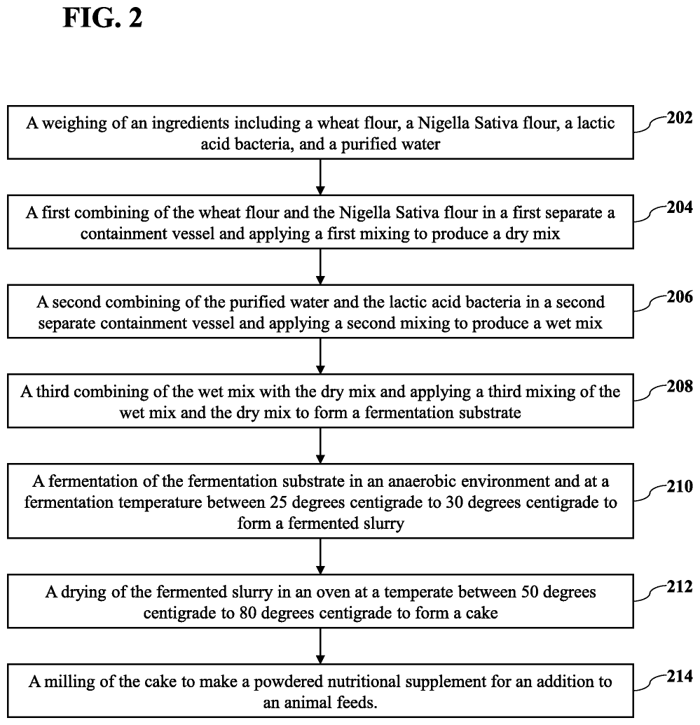

### DETAILED DESCRIPTION OF THE PREFERRED EMBODIMENTS

Embodiments of systems, components, and methods of assembly and manufacture will now be described with reference to the accompanying figures. Although several embodiments, examples, and illustrations are disclosed below, it will be understood by those of ordinary skill in the art that the embodiments described herein extend beyond the specifically disclosed configurations, examples, and illustrations, and can include other users of the disclosure and obvious modifications and equivalents thereof. The terminology used in the descriptions presented herein is not intended to be interpreted in any limited or restrictive manner simply because it is being used in conjunction with a detailed description of certain specific embodiments of the disclosure. In addition, embodiments of the disclosure can comprise several novel features and no single feature is solely responsible for its desirable attributes or is essential to practicing any one of the several embodiments herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” “top,” “bottom” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specially mentioned above, derivatives thereof, and words of similar import. The term cattle supplement, livestock supplement, and powdered nutritional supplement may be used interchangeably herein.

Referring to the drawings, like reference numerals designate identical or corresponding features throughout the several views. Described herein are certain non-limiting embodiments of a universally mountable modular data and power node 100 for use in the application and support of smart home features and functions therein.

The fermentation process that may be described herein may be of a homofermentative type where the final product is only lactate acid. Moreover, the use of black cumin flour in combination with wheat flour may be an ideal initial medium and/or substrate that is subsequently fermented using lactic acid bacteria (LAB) to produce a high nutritional natural supplement that may be further described throughout these various embodiments.

This disclosure may describe the main ingredients for a livestock supplement made by a fermentation process using a substrate of a mixture of Nigella sativa flour and wheat flour. The fermentation agent used may be a lactate acid bacteria (LAB). The composition of the ingredients may be a wheat flour of 40%-50%, a Nigella sativa flour of 10%-30%, a measure of purified water of 20%-30%, and lactic acid bacteria LAB of 5%-25%, as a measure of total weight or composition of the aforementioned ingredients. The production process may start by weighing the ingredients, mixing and stirring, fermenting, drying using an oven, and flouring using a disk mill until a final product consisting of less than 100 meshes. The final product may have high nutritional content and may be applied as the additional content of the cattle food such as pure, pellet, and crumble.

The production process of a supplement made for the cattle that made of Nigella sativa, wheat flour, and LAB fermentation may occur by the following steps:
Main ingredients weighing
Ingredients mixing
Fermentation process
Drying process
Flouring process

The composition of Nigella sativa may be about 10% to 30% out of the total weight or percent composition. The composition of wheat flour may be about 40% to 50% out of the total weight or percent composition. The composition of purified water may be about 20% to 30% out of the total weight or percent composition. The composition of LAB may be about 5% to 25% out of the total weight or percent composition. The LAB that is used during the fermentation process may be one of the following micro-organisms, Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella. The aforementioned list is not exhaustive nor exclusive. The fermentation process may be done within a chamber of an anaerobic environment for 3 to 7 days at a range between 25 degrees centigrade to 30 degrees centigrade. The fermentation process byproduct may be dried using an oven set to a range between 50 degrees centigrade to 80 degrees centigrade. The flouring process may be performed using a disk mill until the dried byproduct is floured with standard mesh sizes less than 100. The flour produced may be the final product of the supplement. This supplement has a high nutritional content and may be applied as a supplement for livestock, or as an addition to other livestock feed such as pure, pellet, and crumble.

Having disclosed the structure of the preferred embodiments, it is now possible to describe its function, operation, and use.

Lactic acid fermentation is a metabolic process by which glucose and other 6-carbon sugars may be converted into cellular energy and the metabolite lactate, which is the lactic acid in solution. Moreover, lactic acid fermentation may be considered a respiratory and/or respiration process within an animal or human cell wherein an oxygen requirement is not fulfilled due to excessive work. During the fermentation process, glucose or sugar may be decomposed into two pyruvate acid molecules through the glycolysis process, forming ATP and two NADH (Nicotinamide adenine dinucleotide [+H]). The reaction of a fermentation process may differ from one process with the next process and may depend on the type of base sugar used to form the resulting product. Glucose (C6H12O6) is a simple form of sugar, which through fermentation may produce ethanol (2C2H5OH). This reaction is done by the fermentation agent which may be a lactic acid bacteria (hereinafter LAB). The fermentation as described in this disclosure may be performed using wheat flour and Nigella sativa flour as the main ingredients and LAB as the fermentation agent to produce high nutritional supplement products, especially in protein, which may be beneficial for livestock growth.

As noted, fermentation as described herein may be a process of energy production within a cell in an anaerobic state, which is the state where oxygen doesn't exist or is in limited supply within the fermentation environment. From this description, a fermentation process may be understood simply as a form of respiration within an anaerobic environment. Additionally, the fermentation process may also be described as a respiration process that not only happens within an anaerobic environment but also without an external electron acceptor. An electron acceptor may be a chemical entity that accepts electrons transferred to it from another compound, it may be an oxidizing agent by accepting an electron, and the electron acceptor may itself be reduced in the process.

Sugar may be a common ingredient for fermentation. Several examples of sugar fermentation products are ethanol, lactate acid, and hydrogen. At times butyrate acid and acetone may also be produced through a sugar fermentation process.

The production of lactate acid through fermentation may be a form of anaerobic respiration done in the cell of humans and animals when the requirement for oxygen is not fulfilled. This could happen due to an activity that requires excessive energy and the respiration cycle is incapable of keeping pace with the energy requirements. During this fermentation process, glucose or sugar may be decomposed into two pyruvate acid molecules, two ATP molecules, and two NADH molecules through glycolysis.

The fermentation reaction that might occur differs depending on the base sugar that is used. Different base sugars may result in final products that vary from base sugar to base sugar. From this description, it may be concluded that the biochemical process that occurs during a fermentation process varies, and that depends on the resulting products. However, most of the fermentation process commonly involves a glycolysis process which may be the initial anaerobic respiration process for most organisms.

Ancient microorganisms are suspected to have utilized fermentation as their main method of producing energy. This suspicion is due to the known concentration of oxygen during the Hadean and Archean periods of Earth. The Hadean is a geologic eon of the Earth predating the Archean. It began with the formation of the Earth about 4.6 billion years ago and ended, as defined by the International Commission on Stratigraphy (ICS), 4 billion years ago. The Archean period is the geologic eon of Earth which came directly after the Hadean and showed the very first signs of photosynthesis. Importantly, photosynthesis is the main producer of atmospheric oxygen. For all single-celled organisms which came before the production of atmospheric oxygen, fermentation represented one of the few methods of cellular energy production. This makes fermentation a primordial form of energy production within a cell.

The final step of a fermentation process may be the conversions of pyruvate acid into a final fermentation product. This step doesn't produce any energy, yet it may be necessary since this step may regenerate nicotinamide adenine dinucleotide (NAD+) that is needed for the glycolysis process. This may be due to glycolysis that serves as the only means for ATP production in an anaerobic respiration process.

Lactic acid bacteria (LAB) may be a family of positive gram bacteria that do not form spores and may be able to ferment a variety of carbohydrates (by way of example only, glucose) to form lactate acid. Based on our current taxonomic understanding, there may be about twenty genera of bacteria that belong to the family of LAB. Those bacteria may be Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella. The aforementioned list is not exclusive, nor is it exhaustive as novel species of microorganisms are routinely discovered and may be added to this list at any time.

Some LAB are aerotolerant anaerobes, which means that they can grow and survive within an oxygen-containing environment, while some other are obligate anaerobes that cannot survive in an oxygen-rich environment. Bacteria classified as LAB have certain characteristics which include: a lack of porphyrin and cytochrome, negative catalase, no phosphorylation of electron transport and may only obtain energy from phosphorylation of the substrate.

Fermentation processes that produce lactate acid may be divided into two types, which are homofermentative, wherein the final products are mostly lactate acid, and heterofermentative, wherein the final products are lactate acid, hydrogen, ethanol, and some acetate acid. Nevertheless, both types may have a similarity in the way they produce lactate acid, which is through the conversion of pyruvate acid formed from glycolysis. This process is also followed by the exertion of NADH electron so it will become NAD+. This process can be differed to be one of the two types by observing the existence of enzymes involved during the glycolysis metabolism process.

Most of LAB may have the potential to bring a positive impact for humans, such as increasing the nutrition within the food, increasing the digestion of lactose, controlling infection within the intestine, and balancing blood content. Some LAB may also have an impact on livestock, such as reducing pathogens such as E. coli and Salmonella. LAB could also be consumed by livestock as a probiotic bacteria, which may increase the health and nutrition of the body.

Nigella sativa, or black cumin, may be an herbal plant that displays growth pattern which represents the classification of an annual plant. It may be among the family of Ranunculaceae and may originate from the Mediterranean Sea. Black cumin may be believed to cure several diseases such as flu, headache, fever, asthma, hypertension, rheumatic type diseases, and other bacteria-caused diseases. This plant is also believed to be able to increase the health of the body by protecting the functions of kidneys, bile, liver, and strengthen the immune system. This plant, not only affect the health of humans but also animals. The taxonomy of Nigella sativa may be as follows:
Kingdom: Plantae
Division: Spermatophyta
Class: Dicotyledoneae
Family: Ranunculaceae
Genus: Nigella
Species: Nigella sativa.

Nigella sativa may contain saponins, polyphenols, essential oils, fatty oils, melanin, nigelin, nigellone, thymoquinone, and other compounds. The chemical composition of the seeds of the Nigella sativa plant is shown on the table below, the values represent an average for every 100 grams of seeds:

Table of compositions of Nigella sativa seed.

| Compositions | Quantity (mg/100 g) |
|---|---|
| Water | 6.4 ± 0.15 |
| Fat | 32.0 ± 0.54 |
| Crude fiber | 6.6 ± 0.69 |
| Protein | 20.2 ± 0.82 |
| Ash | 4.0 ± 0.29 |
| Carbohydrate | 37.4 ± 0.87 |

Source: Nergiz and Otles, 1993

Nigella sativa may contain unsaturated fatty acids and essential fatty acids which may be linoleate acid. A complete composition of fatty acid and sterol within this plant is shown in the table below:

Table of the composition of fatty acids
and sterol within Nigella sativa seed.

| | Quantity (mg/100 g) |
|---|---|
| Fatty acid | |
| Myristic (C14:0) | 1.2 ± 0.04 |
| Palmitic (C16:0) | 11.4 ± 1.00 |
| Stearate (C18:0) | 2.9 ± 0.24 |
| Oleic (C18:1) | 21.9 ± 1.00 |
| Linoleate (C18:2) | 60.8 ± 2.67 |
| Eicosadienoic | 1.7 ± 0.11 |
| Sterol | |
| Campesterol | 11.9 ± 0.99 |
| Stigmasterol | 18.6 ± 1.52 |
| B-sitosterol | 69.4 ± 2.78 |

Source: Nergiz and Otles, 1993

The composition of tocopherol and polyphenol within the seed of Nigella sativa may show the existence of a phenolic compound which may be the main component that serves as a medicine and to increase stamina. The composition of tocopherol and polyphenol from Nigella sativa oil can be seen from the table below:

Table of compositions of tocopherol and polyphenol
found on Nigella sativa oil.

| Compositions | Quantity (mg/100 g) |
|---|---|
| Total tocopherol | 340 ± 8.66 |
| Alfa-tocopherol | 40 ± 10 |
| Beta-tocopherol | 50 ± 15 |
| Gamma-tocopherol | 250 ± 13 |
| Total polyphenol | 1744 ± 10.6 |

Source: Nergiz and Otles 1993

Table of compositions of vitamins within
the seed of Nigella sativa.

| Vitamin | Quantity (mg/100 g) |
|---|---|
| B1 (thiamin) | 831 ± 11.36 |
| B2 (riboflavin) | 63 ± 3.32 |
| B6 (Pyridoxine) | 789 ± 8.89 |
| Niacin | 6311 ± 16.52 |
| Folate acid | 42 ± 4.58 |

Source: Nergiz and Otles 1993

Table of compositions of amino acid within Nigella sativa seed.

| Amino acid | Quantity (mg/100 g) |
|---|---|
| Alanine | 3.77 |
| Valine | 3.06 |
| Glycine | 4.17 |
| Isoleucine | 4.03 |
| Leucine | 10.88 |
| Prolin | 5.34 |
| Threonine | 1.23 |
| Serine | 1.98 |
| Aspartic acid | 5.02 |
| Methionine | 6.16 |
| Phenylalanine | 7.93 |
| Glutamic Acid | 13.21 |
| Tyrosine | 6.08 |
| Lysine | 7.62 |
| Arginine | 19.52 |

Nigella sativa may have several benefits which are antibacterial, antitumor, and anti-inflammatory, and may be able to increase the immune system functioning of the body. The various benefits of Nigella sativa may have resulted in this plant being used as an herbal medicine for humans during pre-civilization through today. The substances contained within the black cumin may replace the need for additional antibiotics, thus increasing livestock immunity.

The addition of Nigella sativa to chicken feed may increase the performance of the lymphoid organs, and the lymphatic system generally. Additionally, said addition may aid in reducing the total pellet consumption rate, may increase total protein digestion, and may reduce abdominal fat quantity, thus reducing the feed conversion ratio (FCR). Studies may suggest that the addition of Nigella sativa on poultry food, especially chicken feed, may increase average growth size, may increase egg production and quality, may be used to replace antibiotics, and may be an effective countermeasure against pathogenic microorganisms.

Additionally, when Nigella sativa is added to cow or buffalo feed, it may function to replace other sources of concentrated protein without affecting the performance and the health of the livestock. The addition of Nigella sativa to rabbit, bird, and fish food may also increase the antibody concentration in response to the albumin serum, reduce the growth of pathogenic microorganisms, and may maximize systemic immune responses towards infections.

The formulation of a supplement made of Nigella sativa fermentation is shown below.

| Wheat | Nigella sativa | Fermentation | De-Ionized |
|---|---|---|---|
| flour | flour | agent | water |
| 40%-50% | 10%-30% | 5%-25% | 20%-30% |

The fermentation may be completed with the main ingredient of wheat flour and Nigella sativa flour using lactic acid bacteria as the fermentation agent. This method may produce a supplement product that is rich in protein and nutritional content that is good for the growth of the cattle. The final product of Nigella sativa fermentation makes the supplement is easy to be digested by the cattle.

Procedure of Supplement Production

1. The Weighing of Ingredients

The main ingredients that are used in the supplement production process for livestock (fish, bird, rabbit, chicken, cow, and other cattle) may be wheat flour, Nigella sativa flour, lactate acid bacteria as the fermentation agent, and purified water. (Said water purification may occur through filtration, distillation, or other means known to the arts such as reverse osmosis). The main ingredients chosen are of high quality and hygienically processed. The composition of the wheat flour may be 40%-50%, Nigella sativa flour may be 10%-30%, purified water may be 20%-30%, and the LAB fermentation agent may be 5-25%. The stated percentages may vary, these are used for exemplary purposes only, and may further constitute a percent by weight measure or a percent composition measure.

2. Ingredients Mixing

The ingredients that have been weighted may then be poured into the mixer. The pouring of the ingredients may start with the dry ingredients which may be Nigella sativa flour and wheat flour, which may then be stirred until homogenization is achieved. The purified water and the fermentation agent may then be poured and homogenized in a different beaker. After both have been homogenized, both mixes may be combined as one and may be stirred until the homogenization of all ingredients is achieved.

3. Fermentation Process

The homogenized mix of all ingredients may produce a homogenized ingredient which may then be fermented within an isolated chamber and in an anaerobic environment. An anaerobic environment as defined herein either lacks oxygen or is an environment wherein the oxygen content is reduced. The fermentation may occur over the course of three to seven days. The chamber temperature may be controlled to maintain a range of 25 degrees centigrade 30 degrees centigrade. A temperature-controlled environment is one in which the temperature may be highly regulated and controlled.

4. Drying Process

After fermentation is done, the next step may be drying the fermented product using an oven. This drying process is done controlled to maintain a range of 50 degrees centigrade to 80 degrees centigrade. The dried fermentation slurry may be referred to as a cake.

5. Flouring Process

The next step may be the formation of flour out of the dried fermentation product using a disk mill. The flouring process may also be referred to as milling. The milling of the cake may form a powdered nutritional supplement. This process may proceed until the final product is below 100 meshes on a commercial mesh sieve scale. The flour, also referred to as a powdered nutritional supplement, may have a high nutritional content, and this product may be applied as a supplement livestock feed. This product (powdered nutritional supplement) may also be applied as additional content of regular livestock food such as pure, pellet, and crumble.

The main ingredients for the cattle supplement made by a fermentation process may be Nigella sativa flour and wheat flour. The fermentation agent used may be a lactate acid bacteria (LAB). The composition of the ingredients may be that the wheat flour may be 40%-50%, Nigella sativa may be 10%-30%, purified water may be 20%-30%, and LAB may be 5%-25% out of the total weight or composition of the ingredients. The production process may start by weighing the ingredients, mixing and stirring, fermentation, drying using an oven, and flouring using a disk mill until a final product consisting of less than 100 meshes is produced. The final product may have high nutritional content and may be applied as the additional content of the cattle food such as pure, pellet, and crumble.

Herein described may be a method for making a powdered nutritional supplement for animal feed. The method may be described as involving a series of steps; however, it should be noted that these steps are not necessarily chronological in order, and do necessarily depend on the completion of each step before initiating the subsequent step(s). Only where the completion of a prior step is necessary for a subsequent step may any inference be rendered as to chronological order. Accordingly, the method may involve the following steps:
a) weighing one or more than one dry ingredients and wet ingredients;
b) combining the dry ingredients;
c) combining the wet ingredients;
d) combining the wet ingredients with the dry ingredients;
e) a mixing of the ingredients to form a fermentation substrate;
f) a fermentation of the fermentation substrate to form a fermented slurry;
g) drying of the fermented slurry to form a cake; and
h) milling of the cake to make a powdered nutritional supplement for the addition to animal feeds.

Additional embodiments of the above may be included and may be described as involving a series of steps; however, it should be noted that these steps are not necessarily chronological in order, and do necessarily depend on the completion of each step before initiating the subsequent step(s). Only where the completion of a prior step is necessary for a subsequent step may any inference be rendered as to chronological order. Accordingly, the method may be as follows:
a) a weighing of ingredients including wheat flour, a Nigella sativa flour, a lactic acid bacteria, and purified water;
b) a first combining of the wheat flour and the Nigella sativa flour in a first separate a containment vessel and applying a first mixing to produce a dry mix;
c) a second combining of the purified water and the lactic acid bacteria in a second separate containment vessel and applying a second mixing to produce a wet mix;
d) a third combining of the wet mix with the dry mix and applying a third mixing of the wet mix and the dry mix to form a fermentation substrate;
e) fermentation of the fermentation substrate in an anaerobic environment and at a fermentation temperature between 25 degrees centigrade to 30 degrees centigrade to form a fermented slurry;
f) drying of the fermented slurry in an oven at a temperate between 50 degrees centigrade to 80 degrees centigrade to form a cake; and
g) milling of the cake to make a powdered nutritional supplement for the addition to animal feeds.

Additional embodiments of the above may be included and may be described as involving a series of steps; however, it should be noted that these steps are not necessarily chronological in order, and do necessarily depend on the completion of each step before initiating the subsequent step(s). Only where the completion of a prior step is necessary for a subsequent step may any inference be rendered as to chronological order. Accordingly, the method may be as follows:
a) a first weighing of wheat flour;
b) a second weighing of a Nigella sativa flour;
c) a third weighing of a lactic acid bacteria selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella;
d) a fourth weighing of purified water;
e) a first combining of the wheat flour and the Nigella sativa flour in a first separate a containment vessel and applying a first mixing to produce a dry mix;
f) a second combining of the purified water and the lactic acid bacteria in a second separate containment vessel and applying a second mixing to produce a wet mix; and,
g) a third combining of the wet mix with the dry mix and applying a third mixing of the wet mix and the dry mix to form a fermentation substrate;
h) wherein the wheat flour is 40 to 50 weight percent of the fermentation substrate, the Nigella sativa flour is 10 to 30 weight percent of the fermentation substrate, the lactic acid bacteria is 5 to 25 weight percent of the fermentation substrate, and the purified water is 20 to 30 weight percent of the fermentation substrate.
i) fermentation of the fermentation substrate in an anaerobic environment and at a fermentation temperature between 25 degrees centigrade to 30 degrees centigrade to form a fermented slurry;
j) drying of the fermented slurry in an oven at a temperate between 50 degrees centigrade to 80 degrees centigrade to form a cake; and,
k) milling of the cake with a disk mill to make a powdered nutritional supplement for the addition to an animal feeds until the powdered nutritional supplement has a mesh size below 100.

Additionally disclosed herein may be a fermentable substrate which may comprise a wheat flour of at least 40 weight percent, a Nigella sativa flour at least 10 weight percent, a Lactic Acid Bacteria selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella, of at least 5 weight percent, and, purified water at least 20 weight percent.

While embodiments of the present disclosure have been illustrated and described, it is not intended that these embodiments illustrate and describe all possible forms of this disclosure. Rather, the words used in the specification are words of description rather than limitation, and it is understood that various changes may be made without departing from the spirit and scope of the disclosure.

Accordingly, it is not intended that the various embodiments be limited except by the appended claims. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A method for producing an animal feed supplement comprising:
a weighing one or more than one a dry ingredients and a wet ingredients;
a combining of the dry ingredients;
a combining of the wet ingredients;
a combining of the wet ingredients with the dry ingredients;
a mixing of the ingredients to form a fermentation substrate;
a fermentation of the fermentation substrate to form a fermented slurry;
a drying of the fermented slurry to form a cake; and
a milling of the cake to make a powdered nutritional supplement for an addition to an animal feeds.

2. The method for producing an animal feed supplement of claim 1, wherein the fermentation substrate further comprises a wheat flour, a Nigella sativa flour, a lactic acid bacteria, and a purified water.

3. The method for producing an animal feed supplement of claim 2, wherein the lactic acid bacteria is selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella.

4. The method for producing an animal feed supplement of claim 2, wherein the wheat flour is 40 to 50 percent weight of the fermentation substrate.

5. The method for producing an animal feed supplement of claim 2, wherein the Nigella sativa flour is 10 to 30 percent weight of the fermentation substrate.

6. The method for producing an animal feed supplement of claim 2, wherein the lactic acid bacteria is 5 to 25 percent weight of the fermentation substrate.

7. The method for producing an animal feed supplement of claim 2, wherein the purified water is 20 to 30 percent weight of the fermentation substrate.

8. The method for producing an animal feed supplement of claim 1, wherein the fermentation of the fermentation substrate occurs in an anaerobic environment.

9. The method for producing an animal feed supplement of claim 1, wherein the fermentation of the fermentation substrate occurs in a temperature-controlled environment.

10. The method for producing an animal feed supplement of claim 1, wherein the fermentation of the fermentation substrate occurs at a temperature between 25 degrees centigrade to 30 degrees centigrade.

11. The method for producing an animal feed supplement of claim 1, wherein the fermentation of the fermentation substrate occurs over a period of time between 3 to 7 days.

12. The method for producing an animal feed supplement of claim 1, wherein the drying occurs in an oven.

13. The method for producing an animal feed supplement of claim 1 or 12, wherein the oven is set to a temperate between 50 degrees centigrade to 80 degrees centigrade.

14. The method for producing an animal feed supplement of claim 1, wherein a milling of the cake to make a powdered nutritional supplement occurs by the use of a disk mill.

15. The method for producing an animal feed supplement of claim 1 or 14, wherein the disk mill is operated until the cake is powdered to a mesh size of below 100.

16. A method for making a powdered nutritional supplement for animal feed comprising:
a weighing of an ingredients including a wheat flour, a Nigella sativa flour, a lactic acid bacteria, and a purified water;
a first combining of the wheat flour and the Nigella sativa flour in a first separate a containment vessel and applying a first mixing to produce a dry mix;
a second combining of the purified water and the lactic acid bacteria in a second separate containment vessel and applying a second mixing to produce a wet mix;
a third combining of the wet mix with the dry mix and applying a third mixing of the wet mix and the dry mix to form a fermentation substrate;
a fermentation of the fermentation substrate in an anaerobic environment and at a fermentation temperature between 25 degrees centigrade to 30 degrees centigrade to form a fermented slurry;
a drying of the fermented slurry in an oven at a temperate between 50 degrees centigrade to 80 degrees centigrade to form a cake; and
a milling of the cake to make a powdered nutritional supplement for an addition to an animal feeds.

17. The method for producing an animal feed supplement of claim 2, wherein the lactic acid bacteria is selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella.

18. The method for producing an animal feed supplement of claim 16, wherein the wheat flour is 40 to 50 weight percent of the fermentation substrate.

19. The method for producing an animal feed supplement of claim 16, wherein the Nigella sativa flour is 10 to 30 weight percent of the fermentation substrate.

20. The method for producing an animal feed supplement of claim 16, wherein the lactic acid bacteria is 5 to 25 weight percent of the fermentation substrate.

21. The method for producing an animal feed supplement of claim 16, wherein the purified water is 20 to 30 weight percent of the fermentation substrate.

22. The method for producing an animal feed supplement of claim 16, wherein a milling of the cake to make a powdered nutritional supplement occurs by the use of a disk mill.

23. The method for producing an animal feed supplement of claim 16, wherein the disk mill is operated until the cake is powdered to a mesh size of below 100.

24. A method for making a powdered nutritional supplement for animal feed comprising:
a first weighing of a wheat flour;
a second weighing of a Nigella sativa flour;
a third weighing of a lactic acid bacteria selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella;
a fourth weighing of a purified water;
a first combining of the wheat flour and the Nigella sativa flour in a first separate a containment vessel and applying a first mixing to produce a dry mix;
a second combining of the purified water and the lactic acid bacteria in a second separate containment vessel and applying a second mixing to produce a wet mix; and,
a third combining of the wet mix with the dry mix and applying a third mixing of the wet mix and the dry mix to form a fermentation substrate;
wherein the wheat flour is 40 to 50 weight percent of the fermentation substrate, the Nigella sativa flour is 10 to 30 weight percent of the fermentation substrate, the lactic acid bacteria is 5 to 25 weight percent of the fermentation substrate, and the purified water is 20 to 30 weight percent of the fermentation substrate;
a fermentation of the fermentation substrate in an anaerobic environment and at a fermentation temperature between 25 degrees centigrade to 30 degrees centigrade to form a fermented slurry;
a drying of the fermented slurry in an oven at a temperate sufficient to completely dry the fermented slurry to form a cake without causing material degradation;
a milling of the cake with a disk mill to make a powdered nutritional supplement for an addition to an animal feeds until the powdered nutritional supplement has a mesh size below 100.

25. The method for making a powdered nutritional supplement for animal feed of claim 24, wherein the powdered nutritional supplement is applied to feed for a livestock animal.

26. A fermentable substrate comprising:
a wheat flour at least 40 weight percent;
a Nigella sativa flour at least 10 weight percent;
a Lactic Acid Bacteria selected from a group of bacterial species consisting of Aerococcus, Bifidobacterium, Carnobacterium, Enterococcus, Lactococcus, Lactobacillus, Leuconostoc, Oenococcus, Pediococcus, Streptococcus, Tetragenococcus, Vagococcus, and Weissella, of at least 5 weight percent; and,
a purified water at least 20 weight percent.

28. The fermentable substrate of claim 26, wherein the wheat flour is 40 to 50 weight percent of the fermentation substrate.

29. The fermentable substrate of claim 26, wherein the Nigella sativa flour is 10 to 30 weight percent of the fermentation substrate.

30. The fermentable substrate of claim 26, wherein the lactic acid bacteria is 5 to 25 weight percent of the fermentation substrate.

31. The fermentable substrate of claim 26, wherein the purified water is 20 to 30 weight percent of the fermentation substrate
